(19) United States
(12) Patent Application Publication
(10) Pub. No.: US 2004/0226576 A1
(43) Pub. Date: Nov. 18, 2004

(54) In-situ landing light cleaning apparatus

(76) Inventor: Martin Hambalek, Bloomington, CA (US)

Correspondence Address: Karl M. Steins, Steins & Associates, Suite 120, 2333 Camino del Rio South, San Diego, CA, 92108, US

(21) Appl. No.: 10/436,847

(22) Filed: May 12, 2003

(51) Int. Cl. B08B 7/00; A46B 13/02

(52) U.S. Cl. 134/6; 15/23; 15/28; 15/104.04

(57) ABSTRACT

An In-Situ Landing Light Cleaning Apparatus is disclosed. Also disclosed is an apparatus that permits the user to easily and thoroughly clean landing light lenses without the need for their removal and transportation to a remote cleaning machine. The apparatus has a cylindrical arrangement of brush bristles directed inwardly from a cylindrical substrate. The cylindrical substrate may be attachable to a conventional power drill or other rotating power tool by a shaft such that the cylinder can be power-rotated. The cylindrical brush member having the brush bristles is detachable so that new bristles can be installed when wear and tear mandates it. The cylindrical substrate further has a closed top end portion having a flat bristle brush insert for cleaning the top surface of the lenses.

### BACKGROUND OF THE INVENTION

1. Field of the Invention

This invention relates generally to cleaning devices and methods and, more specifically, to an In-Situ Landing Light Cleaning Apparatus

2. Description of Related Art

FIG. 1 depicts a conventional airport runway landing light assembly. Hundreds of these landing light assemblies are disbursed alongside each and every runway in virtually every country in the world.

The assembly 10 typically is made up of a base plate 16, which is held down to an electrical junction box or other mounting location by a plurality of bolts or other conventional means for attachment. In the typical arrangement, the assembly 10 has an aluminum pedestal 14 extending upwardly from the base plate 16. The purpose of the pedestal 14 is to raise the level of the light above the level of the grade such that it is at the appropriate viewing height; the pedestal 14 height may vary from assembly to assembly 10.

The pedestal 14 houses the actual lamp that produces the light and the electrical service necessary to illuminate the lamp (not shown). The lamp is protected from environmental elements by a glass landing light lens 12. The lens 12 is made from thick, heavy-duty glass in a variety of colors, and it attaches to the pedestal by threaded engagement.

Since the assembly 10 is necessarily out in the open and exposed to the weather, animals and other outdoor environmental conditions, the lenses 12 become soiled over time, and therefore must periodically be cleaned. Historically, the method of cleaning these lenses 12 has been to remove them one at a time, replace each lens 12 with a standby lens, and then take the lenses to another location for washing. As will be discussed below, this process can consume nearly one hour for a two-person team, making their throughput only about 200 lens cleanings per day.

An alternate, method for cleaning the lenses 12 is to use a handheld (flat) scrub brush and a bucket of water; while this method does save time by avoiding the need for removing the lenses, it doesn't produce a particularly good result (i.e. clean lenses) in many cases. What is needed is an apparatus and method for use thereof that reduces the amount of time required to clean landing light lenses.

### SUMMARY OF THE INVENTION

In light of the aforementioned problems associated with the prior devices and methods, it is an object of the present invention to provide an In-Situ Landing Light Cleaning Apparatus. The apparatus should permit the user to easily and thoroughly clean landing light lenses without the need for their removal and transportation to a remote cleaning machine. The apparatus should have a cylindrical arrangement of brush bristles directed inwardly from a cylindrical substrate. The cylindrical substrate should be attachable to a conventional power drill or other rotating power tool by a shaft such that the cylinder can be power-rotated. The member having the brush bristles should be detachable so that new bristles can be installed when wear and tear mandates it. The cylindrical substrate should further have a closed top end portion having a flat bristle brush insert for cleaning the top surface of the lenses.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, of which:

FIG. 1 is a perspective view of a conventional runway landing light assembly;

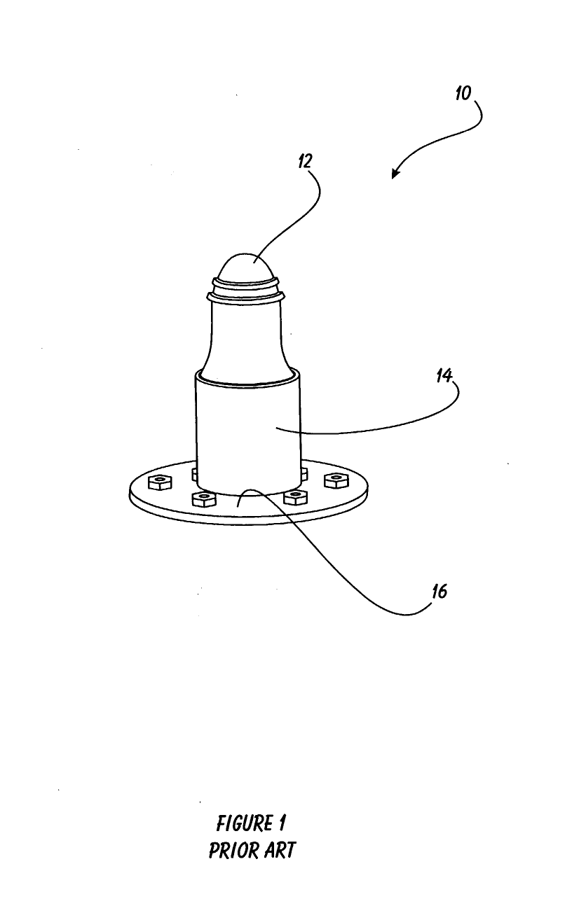

FIG. 2 is a flowchart depicting the conventional process for the periodic cleaning of landing light lenses;

FIG. 3 is a flowchart depicting the improved landing light lens cleaning process of the present invention;

FIGS. 4A and 4B are perspective and side views, respectively, of a preferred embodiment of the landing light lens cleaning apparatus of the present invention; and

FIG. 5 is an exploded perspective view of the apparatus of FIGS. 4A and 4B.

### DETAILED DESCRIPTION OF THE PREFERRED EMBODIMENTS

The following description is provided to enable any person skilled in the art to make and use the invention and sets forth the best modes contemplated by the inventor of carrying out his invention. Various modifications, however, will remain readily apparent to those skilled in the art, since the generic principles of the present invention have been defined herein specifically to provide an In-Situ Landing Light Cleaning Apparatus.

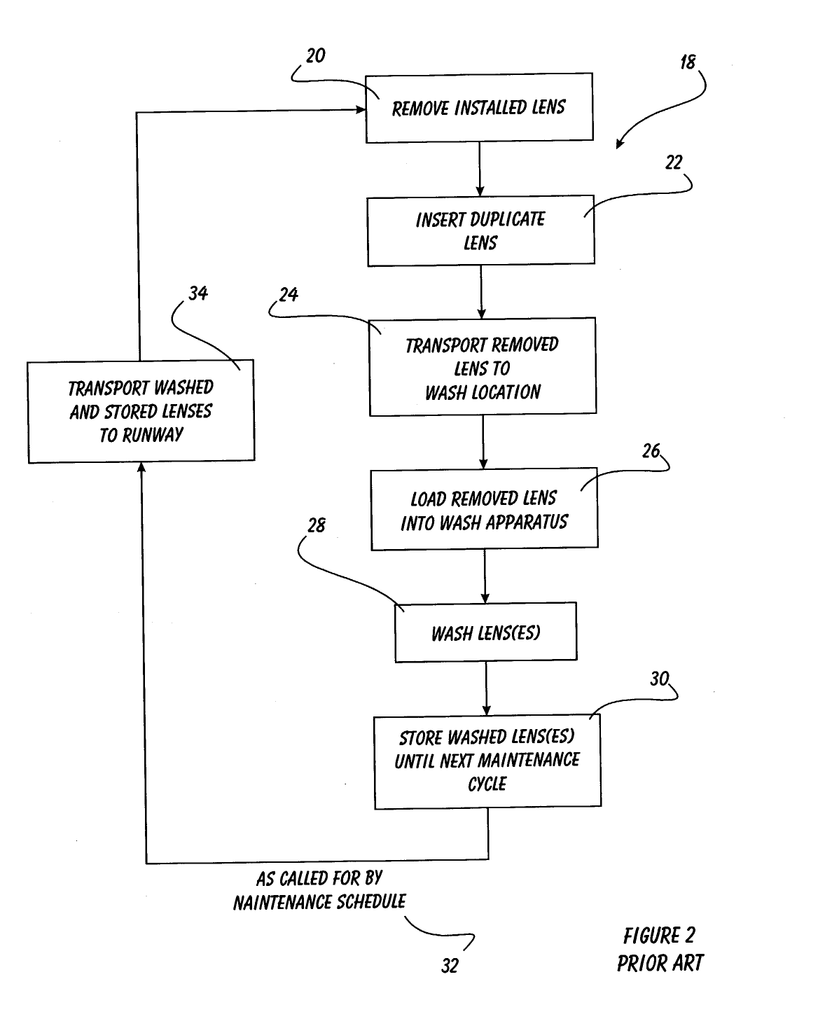

The present invention can best be understood by first considering FIG. 2. FIG. 2 is a flowchart depicting the conventional process 18 for the periodic cleaning of landing light lenses. First, the team (usually two persons) removes an installed lens 20. Next, a duplicate or standby lens is installed in the removed lens' place 22 in order to enable the runway to be placed back in operation once all of a load of lenses has been removed.

Next, the team transports the removed lens (usually a manageable group of lenses is collected for cleaning) to the washing machine location 24. Next the lenses are loaded into the washing machine or apparatus 26 (usually a conventional dishwasher). The wash machine is then run, thereby washing the lenses 28. Next, the lenses are either stored for future exchange with other lenses to be cleaned, or they are actually used at that time for replacement of dirty lenses. When called for by the maintenance schedule 32, the cleaned/stored lenses are transported to the installed lenses' locations 34 and the process is recommenced.

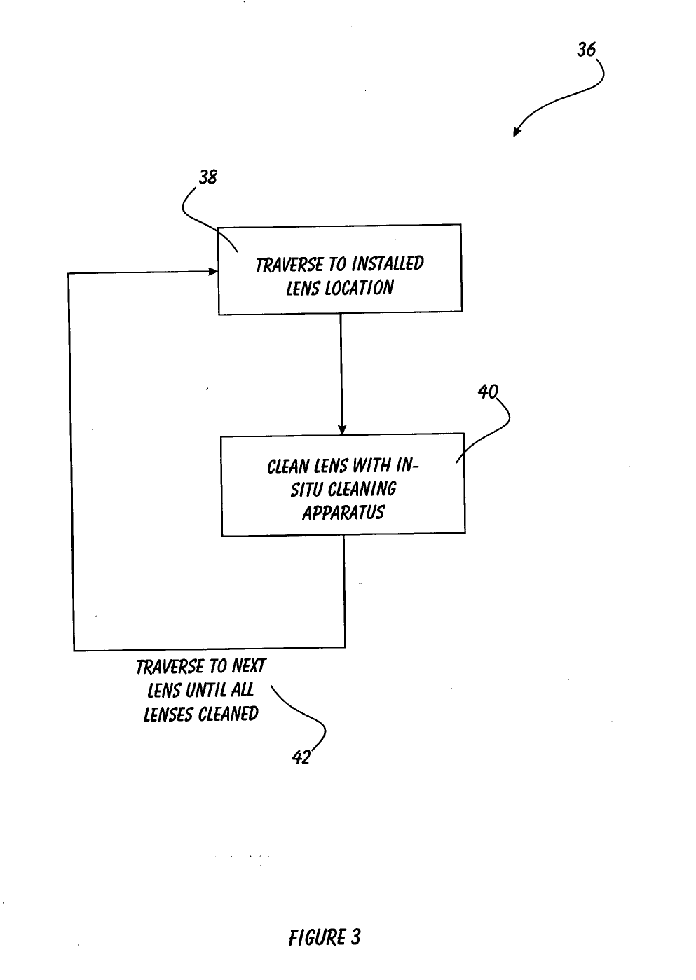

This process is typically undertaken at least three times in a year; if there are one thousand (1000) landing lights on a typical airport, it would take two persons about five (5) days to finish the cleaning, or 30 man-days per year. Furthermore, it is necessary to have at least one set of lenses available on hand for starting the maintenance each time. At up to thirty dollars per lens, the lens cost alone to maintain the standby set can be up to thirty (30) thousand dollars! These costs can be reduced substantially though use of the device and method of the present invention—FIG. 3 introduces its operation.

FIG. 3 is a flowchart depicting the improved landing light lens cleaning process 36 of the present invention. First, the two-person team traverses to a particular landing light location 38. Next, a person sprays the lens with cleaning solvent (usually soapy water) and scrubs the lens in-situ 40— without removing the lens from the assembly. The team then traverses to the next landing light assembly location until all of the lenses have been cleaned 42.

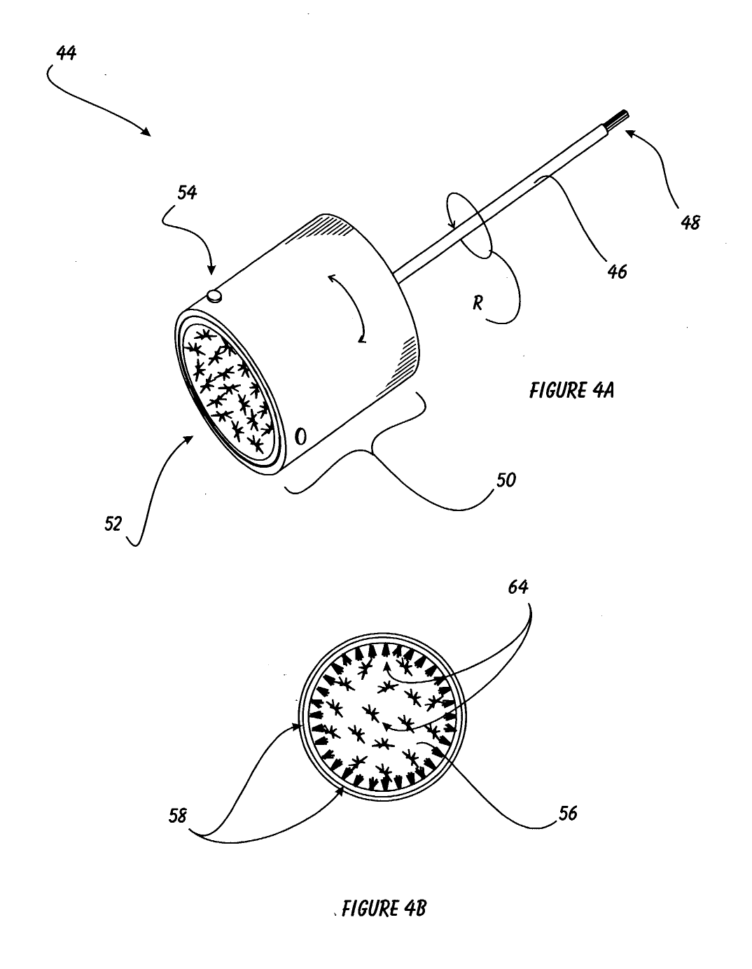

Using the device to be described below and the method herein discussed, each lens is cleaned in less than five (5) minutes! In fact, it is common for a team to clean 1500 lenses in a single day. Furthermore, a single person can also handle the cleaning alone, and while slightly slower than a two-person team, can still exceed 1000 lenses per day. A one-person team, therefore, can be expected to only take 3 man-days a year to clean 1000 landing lights—this is a ninety percent (90%) reduction in salary cost! Also, since the lenses are not being removed and replaced, there is no need for a standby set of lenses. In fact, lens loss due to breakage is expected to reduce because the lenses aren't being handled nearly as much under the process 36 of the present invention as they were under the conventional process (see FIG. 2). If we now turn to FIGS. 4A and 4B, we can examine the details of this new device.

FIGS. 4A and 4B are perspective and side views, respectively, of a preferred embodiment of the landing light lens cleaning apparatus 44 of the present invention. The apparatus 44 comprises a cylindrical brush canister assembly 50, from which extends a drive shaft 48. The drive shaft 48 terminates at its distal end 48 in a rifled section that is adapted to be accepted within a conventional cordless electric drill (or corded drill, of course). As should be apparent, operating the drill causes the drive shaft 48 to rotate (see direction “R”).

The center of the brush canister assembly 50 has a cylindrical brush insert 52 held therein by a plurality of mounting bolts 54. In order to clean a lens, it is a simple matter to place the cylindrical brush insert 52 over a lens, and then operating the drill (not shown) to rotate the apparatus 44 until the lens is cleaned.

As shown in FIG. 4B, the bristles 64 are disbursed around substantially the entire perimeter 58 of the brush insert 52, as well as being disbursed across the face of the top brush insert 56, such that the top and sides of the lens are agitated by the bristles 64 when the apparatus is operated.

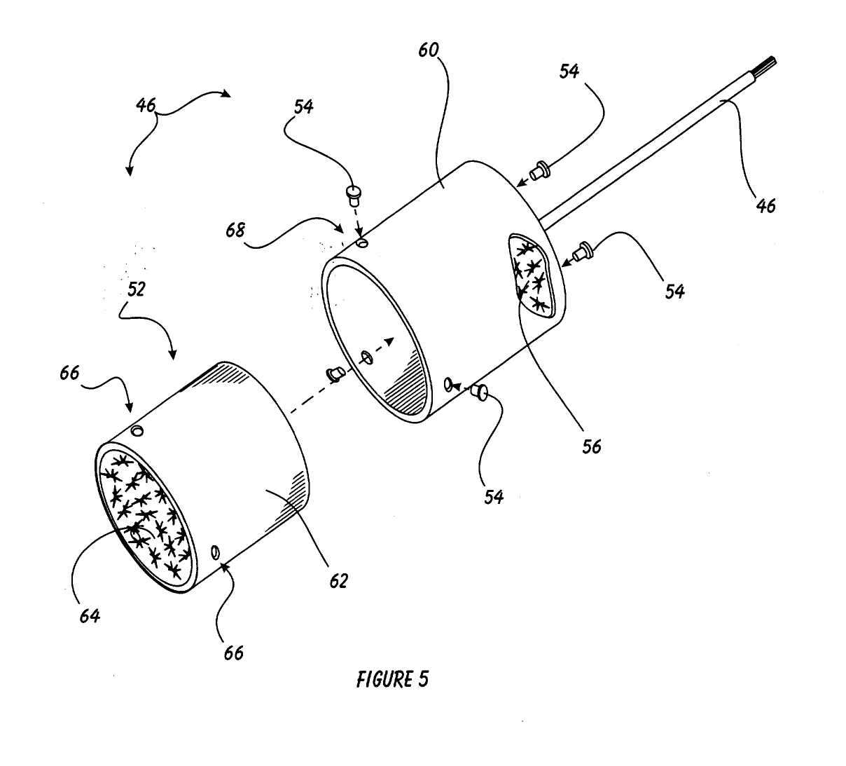

FIG. 5 is an exploded perspective view of the apparatus 46 of FIGS. 4A and 4B. The canister portion 60 of the apparatus is essentially a steel, aluminum (or other strong material) cylinder having an open end 61 and a closed end 63 at its top (where the drive shaft 48 extends). Attached to the inside surface of the closed end 63 is the top brush insert 56; the insert 56 is held in place (detachably) by two or more bolts 54 or other conventional attachment means.

The cylindrical brush insert 52 is formed from a cylindrical substrate 62 having a plurality of bristles 64 disbursed around its inner surface. The substrate 62 is shaped and sized to slip easily yet snugly into the open end 61 of the canister portion 60. The brush insert 52 is preferably made as a flat brush having a plastic substrate 62; the insert is heat treated and formed into the cylindrical shape after the bristles 64 are added to the substrate 62.

The substrate 62 further has a two or more threaded bores 66 formed therein cooperatively located to align with apertures 68 formed around the periphery of the canister portion 60. Once the cylindrical brush insert 52 is inserted into the canister portion 60, and held in place by bolts 54 inserted through the apertures 68 and into threaded engagement with the cylindrical substrate 62.

When the bristles 64 become worn on the brush inserts 52 and 56, the inserts 52 and 56 can be removed and replaced by removing the bolts 54 and reusing them with the replacement inserts 52 and 56.

Those skilled in the art will appreciate that various adaptations and modifications of the just-described preferred embodiment can be configured without departing from the scope and spirit of the invention. Therefore, it is to be understood that, within the scope of the appended claims, the invention may be practiced other than as specifically described herein.

What is claimed is:

1. An apparatus for cleaning landing light lenses, comprising:
a generally cylindrical brush insert defined by a cylindrical substrate defining a diameter sized to accept a landing light lens therein and a plurality of bristles extending inwardly from the inner surface of said cylindrical substrate; and
a drive shaft attached to said cylindrical brush insert, whereby rotating said drive shaft causes said brush insert to rotate.

2. The apparatus of claim 1, wherein said apparatus further comprises a canister portion having a generally cylindrical shape and a curved inside wall and a flat wall at a closed end, said flat wall defining an inner surface and an outer surface, said drive shaft extending from said outer surface.

3. The apparatus of claim 2, further comprising a top brush insert attached to said inner surface of said closed end.

4. The apparatus of claim 3, wherein said cylindrical substrate of said cylindrical brush insert defines an outer diameter cooperatively sized to fit within said canister portion.

5. The apparatus of claim 4, wherein said cylindrical brush insert and said top brush insert are detachably attached to said canister portion.

6. The apparatus of claim 5, wherein said cylindrical brush insert and said top brush insert are attached to said canister portion with a plurality of bolts.

7. The apparatus of claim 6, wherein said drive shaft is further defined by a distal end having a non-circular cross-section.

8. A method for cleaning landing light assembly lenses, comprising the steps of:
applying an apparatus over said lenses, said apparatus comprising:
a generally cylindrical brush insert defined by a cylindrical substrate defining a diameter sized to accept a landing light lens therein and a plurality of bristles extending inwardly from the inner surface of said cylindrical substrate; and
a drive shaft attached to said cylindrical brush insert, whereby rotating said drive shaft causes said brush insert to rotate; and
rotating said apparatus until said lens is sufficiently clean.

9. The method of claim 8, wherein said applying step comprises said apparatus further comprising a canister portion having a generally cylindrical shape and a curved inside wall and a flat wall at a closed end, said flat wall defining an inner surface and an outer surface, said drive shaft extending from said outer surface.

10. The method of claim 9, wherein said applying step comprises said apparatus further comprising a top brush insert attached to said inner surface of said closed end.

11. The method of claim 10, wherein said applying step comprises said apparatus further comprising said cylindrical substrate of said cylindrical brush insert defining an outer diameter cooperatively sized to fit within said canister portion.

12. The method of claim 11, wherein said applying step comprises said apparatus further comprising said cylindrical brush insert and said top brush insert are detachably attached to said canister portion.

13. The method of claim 12, wherein said applying step comprises said apparatus further comprising said cylindrical brush insert and said top brush insert are attached to said canister portion with a plurality of bolts.

14. The method of claim 13, wherein said applying step comprises said apparatus further comprising said drive shaft is further defined by a distal end having a non-circular cross-section.

15. A runway landing light lens cleaning apparatus, comprising:
a canister portion defined by a closed end and an open end and a generally cylindrical wall forming an inner chamber;
a drive shaft extending from said closed end and terminating in a distal end, said distal end configured to be grasped by a conventional drill;
a top brush insert inserted into said inner chamber and attached to said closed end; and
a cylindrical brush insert inserted into said inner chamber and attached to said cylindrical wall.
